(19) United States
(12) Patent Application Publication
(10) Pub. No.: US 2024/0296367 A1
(43) Pub. Date: Sep. 5, 2024

(54) SOLVING QUADRATIC OPTIMIZATION PROBLEMS OVER ORTHOGONAL GROUPS USING A QUANTUM COMPUTER

(71) Applicant: Google LLC, Mountain View, CA (US)

(72) Inventors: Nicholas Charles Rubin, San Francisco, CA (US); Andrew Zhao, Albuquerque, NM (US)

(21) Appl. No.: 18/381,765

(22) Filed: Oct. 19, 2023

Related U.S. Application Data
(60) Provisional application No. 63/380,139, filed on Oct. 19, 2022.

(51) Int. Cl. G06N 10/60; G06F 17/16

(52) U.S. Cl. CPC G06N 10/60; G06F 17/16

(57) ABSTRACT

Methods, systems, and apparatus for solving quadratic optimization problems over orthogonal groups using quantum computing. In one aspect, a method includes receiving data representing a quadratic optimization problem, wherein decision variables of the quadratic optimization problem take values in an orthogonal group or a special orthogonal group; encoding the quadratic optimization problem as a quantum Hamiltonian, the encoding comprising using a Clifford algebra representation of the group to map orthogonal matrices or special orthogonal matrices in the group to respective quantum states in a Hilbert space; determining an approximate eigenstate of the quantum Hamiltonian; computing expectation values of Pauli operators with respect to the approximate eigenstate, wherein the Pauli operators comprise operators obtained by mapping multiplication operations of the Clifford algebra into the Hilbert space; and rounding the expectation values of the Pauli operators to elements of the orthogonal group to obtain a solution to the quadratic optimization problem.

### CROSS-REFERENCE TO RELATED APPLICATION

This application claims the benefit of U.S. Provisional Application No. 63/380,139, filed Oct. 19, 2022, and titled “Solving Quadratic Optimization Problems Over Orthogonal Groups Using a Quantum Computer,” which is incorporated by reference.

### BACKGROUND

This disclosure relates to quantum computing.

Many optimization problems feature orthogonal matrices as their decision variables. Such problems typically involve the joint alignment of points in Euclidean space by isometries, e.g., within the contexts of structural biology via cryo-EM microscopy and NMR spectroscopy, computer vision, robotics, and sensor network localization. A central difficulty in solving these problems is twofold: first, the orthogonal group is nonconvex, making the optimization landscape challenging to navigate in general. Second, the objectives of these types of problems are typically quadratic or higher order polynomials in the optimization variables.

In the commutative setting, these problems are called quadratic combinatorial optimization problems and take the form

$${max}_{{x}_{1} , … , {x}_{m} ∈ \{ \pm 1 \}} {\sum }_{( u , v ) ∈ E} {C}_{u {v}^{x} {u}^{x} v}$$

where (V, E) represents an undirected graph with m=|V| vertices, x₁, . . . , xₘ represent binary valued decision variables, and C∈ [symbol] ^{m×m} is a positive semidefinite matrix. Quadratic combinatorial optimization problems are NP-hard in general.

In the non-commutative setting, the decision variables x₁, . . . , xₘ can be interpreted as taking values in the group [symbol] ≅O(1) of 1×1 orthogonal matrices, where the group multiplication provides the quadratic form. This follows from a generalization which promotes the decision variables to take values in the group of n×n orthogonal matrices O(n):={R∈ [symbol] ^{n×n}|R^{T}R=Iₙ}, where Iₙ represents the n×n identity matrix. This results in the little non-commutative Grothendieck (LNCG) problem over the orthogonal group, defined by the objective

$${max}_{R , … , {R}_{m} ∈ o ( n )} {\sum }_{( u , v ) ∈ E} 〈 {C}_{uv} , {R}_{u} {R}_{v}^{T} 〉$$

where R, . . . , Rₘ represents the decision variables and each Cᵤᵥ∈ [symbol] ^{n×n} forms a (u, v)-th n×n block of a positive semidefinite matrix C∈ [symbol] ^{nm×nm}. The LNCG problem can also be considered over the special orthogonal group SO(n):={R∈ [symbol] ^{n×n}|R^{T}R=Iₙ, det R=1} where the objective is as given above. While the determinant constraint can potentially further complicate the optimization process, SO(n) is encountered in many applications due to the importance of preserving orientations.

Quadratic combinatorial optimization problems in the commutative setting can be translated into a quantum-information framework due to their equivalence with the classical Ising model, which naturally translates into a quantum spin Hamiltonian. This correspondence is at the center of a large body of work studying the potential of quantum computation for solving combinatorial optimization, broadly under the scopes of quantum annealing and the quantum approximate optimization algorithm.

Generalizations of this idea have also been considered, for instance to the cyclic group [symbol] ₖ of order k>2 (MAX-k-CUT) or to non-commuting spin operators (quantum MAXCUT). In both cases, the objective is mapped to a Hamiltonian whose energy is to be maximized and the decision variables are mapped to quantum states. For example, in MAX-k-CUT, k-dimensional qudits are assigned to each vertex, and the group operation of [symbol] ₖ is represented by the action of the generalized Pauli-X operator on those qudits. However, no such formulation yet exists for LNCG problems, where the structure of the orthogonal group is embodied by the inherent properties of quantum mechanics.

### SUMMARY

This disclosure describes techniques for solving quadratic optimization problems over orthogonal groups using quantum computing.

In general, one innovative aspect of the subject matter described in this specification can be implemented in a method including receiving, by a classical computer, data representing a quadratic optimization problem, wherein decision variables of the quadratic optimization problem take values in an orthogonal group or a special orthogonal group; encoding, by a classical computer, the quadratic optimization problem as a quantum Hamiltonian, the encoding comprising using a Clifford algebra representation of the group to map orthogonal matrices or special orthogonal matrices in the group to respective quantum states in a Hilbert space; determining, by a quantum computer, an approximate eigenstate of the quantum Hamiltonian; computing, by the quantum computer, expectation values of Pauli operators with respect to the approximate eigenstate, wherein the Pauli operators comprise operators obtained by mapping multiplication operations of the Clifford algebra into the Hilbert space; and rounding, by the classical computer, the expectation values of the Pauli operators to elements of the orthogonal group to obtain a solution to the quadratic optimization problem.

Other implementations of these aspects includes corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the orthogonal group comprises an orthogonal group in dimension n≥1 or a special orthogonal group in dimension n≥1, wherein a group operation is given by matrix multiplication.

In some implementations using the Clifford algebra representation of the group to map orthogonal matrices in the group to respective quantum states in the Hilbert space comprises: mapping basis elements of the Clifford algebra in a 2ⁿ-dimensional vector space to respective computational basis states in a Hilbert space of dimension 2ⁿ, wherein n represents the dimension of the group; and mapping a left multiplication operation of the Clifford algebra and a right multiplication operation of the Clifford algebra to respective n-qubit operators on the Hilbert space.

In some implementations the left multiplication operation of the Clifford algebra for an i-th basis element is mapped to an n-qubit operator given by Z^{⊗(i-1)}⊗(−iY)⊗I₂^{⊗(n-i)} and the right multiplication operation of the Clifford algebra for an i-th basis element is mapped to an n-qubit operator given by I₂^{⊗(i-1)}⊗(−iY)⊗Z^{⊗(n-i)}, where Z represents the Pauli Z operator and Y represent the Pauli Y operator.

In some implementations using the Clifford algebra representation of the group to map orthogonal matrices in the group to respective quantum states in the Hilbert space comprises applying a quadratic mapping to elements of the Clifford algebra, wherein the quadratic mapping maps inputs in a vector space with dimension 2ⁿ to respective outputs in a vector space with dimension n×n, wherein matrix elements of each output comprise expectation values of the n-qubit operators on the Hilbert space.

In some implementations the matrix elements of an output of the quadratic mapping comprise expectation values of the n-qubit operators given by

$${P}_{ij} := {λ}_{i}^{†} {ρ}_{j} α = \{ \begin{matrix}- {I}_{2}^{⊗ ( i - 1 )} ⊗ X ⊗ {Z}^{⊗ ( j - i - 1 )} ⊗ X ⊗ {I}_{2}^{⊗ ( n - j )} & i < j \\ {I}_{2}^{⊗ ( i - 1 )} ⊗ Z ⊗ {I}_{2}^{⊗ ( n - i )} & i = j \\ - {I}_{2}^{⊗ ( j - 1 )} ⊗ Y ⊗ {Z}^{⊗ ( i - j - 1 )} ⊗ Y ⊗ {I}_{2}^{⊗ ( n - i )} & i > j\end{matrix} ,$$

where i, j represent Clifford algebra basis indices, X represents the Pauli X operator, Z represents the Pauli Z operator, and Y represent the Pauli Y operator.

In some implementations the matrix elements of an output of the quadratic mapping comprise expectation values of the n-qubit operators given by \tilde{P}ᵢⱼ=Π₀PᵢⱼΠ₀^{T} where

$${\prod }_{0} = \frac{1}{√ 2} ( 〈 + \vert ⊗ {I}_{2}^{⊗ ( n - 1 )} + 〈 - \vert ⊗ {Z}^{⊗ ( n - 1 )} ) ,$$

i, j represent Clifford algebra basis indices, Z represents the Pauli Z operator, and [symbol] +|, [symbol] −| represent a plus state and minus state, respectively.

In some implementations the quadratic optimization problem defines a graph of vertices and edges, and wherein rounding the computed expectation values to elements of the orthogonal group comprises implementing an edge-marginal rounding algorithm.

In some implementations implementing the edge-marginal rounding algorithm comprises: decomposing a square matrix comprising expectation values for the edges in the graph as a product of a rectangular matrix and a transpose of the rectangular matrix; generating a random normally distributed matrix; multiplying the random matrix by the rectangular matrix to obtain a vector of matrices; and for each vertex in the graph, projecting a respective matrix in the vector of matrices to a nearest element in the orthogonal group.

In some implementations projecting a respective matrix in the vector of matrices to a nearest element in the orthogonal group comprises computing a singular value decomposition of the vector of matrices.

In some implementations the quadratic optimization problem defines a graph of vertices and edges, and wherein rounding the computed expectation values to elements of the orthogonal group comprises implementing a vertex-marginal rounding algorithm.

In some implementations implementing the vertex-marginal rounding algorithm comprises, for each vertex in the graph, projecting a matrix comprising expectation values for the vertex to a nearest element in the orthogonal group.

In some implementations projecting a matrix comprising expectation values for the vertex to a nearest element in the orthogonal group comprises computing a singular value decomposition of the matrix comprising expectation values for the vertex.

In some implementations computing expectation values of Pauli operators with respect to the approximate eigenstate comprises: preparing, by the quantum computer, copies of the approximate eigenstate using ground state preparation or approximate ground state preparation techniques; and measuring, by the quantum computer, the copies of the approximate eigenstate, comprising measuring matrix elements of a 1-RDM or 2-RDM.

In some implementations determining the approximate eigenstate of the quantum Hamiltonian comprises performing quantum phase estimation or a variational algorithm, wherein the accuracy of the approximate eigenstate is dependent on the accuracy of the quantum phase estimation computation or variational algorithm.

In some implementations the received data comprises values of elements of a positive semidefinite matrix, and wherein the solution of the quadratic optimization problem comprises the rounded expectation values and the values of the elements of the positive semidefinite matrix.

In some implementations the quantum Hamiltonian comprises two-body fermionic interactions.

In some implementations the quadratic optimization problem comprises a little noncommutative Grothendieck problem over the orthogonal group or special orthogonal group.

In some implementations the eigenstate of the quantum Hamiltonian comprises a maximal eigenstate or an eigenstate that maximizes energy with respect to an initial state.

The subject matter described in this specification can be implemented in particular embodiments so as to realize one or more of the following advantages.

Quadratic optimization over the orthogonal group encompasses a broad class of optimization problems such as group synchronization (which have applications in structural biology, robotics and wireless networking), point-set registration, simultaneous localization and mapping, and generalized orthogonal Procrustes problems (which have applications in fields such as shape and image recognition). These problems are typically computationally inefficient or intractable to solve to high accuracy in all settings using classical computers.

The presently described invention enables such problems to be translated into a quantum information framework so that they can be efficiently solved using quantum computers. Therefore, the presently described techniques for solving quadratic optimization problems over orthogonal groups are particularly adapted for a specific technical implementation—quantum computing. In the present disclosure, the quadratic optimization problem over an orthogonal group is initially formulated for a classical computing device. This formulation is then mapped to a quantum formulation, e.g., a quantum Hamiltonian and corresponding qubit operators. A quantum computer can therefore be used to obtain a solution to the quadratic optimization problem, since quantum computers are able to perform operations required to solved the quantum formulation, e.g., phase estimation, variational algorithms, state preparation and measurements of qubit operators. That is, the presently described techniques are motivated by technical considerations of the internal functioning of the quantum computer.

In addition, the resource of quantum entanglement is expected to provide higher-quality solutions than classical approximation algorithms.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system solving a quadratic optimization problem over an orthogonal group using classical and quantum computation.

FIG. 2 is a flow diagram of an example process for solving a quadratic optimization problem over an orthogonal group using classical and quantum computation.

FIG. 3 is a flow diagram of an example process for edge-marginal rounding of a quantum state.

FIG. 4 is a flow diagram of an example process for vertex-marginal rounding of a quantum state.

FIG. 5 depicts an example quantum computing system.

FIG. 6 illustrates a schematic diagram of an exemplary classical processor system.

### DESCRIPTION

This specification describes techniques for encoding a quadratic optimization problem over the orthogonal group onto a quantum Hamiltonian using a Clifford algebra representation of the orthogonal group. A solution to the quadratic optimization problem can then be obtained by computing a quantum state that optimizes the energy of the quantum Hamiltonian and rounding the quantum state into the feasible solution space.

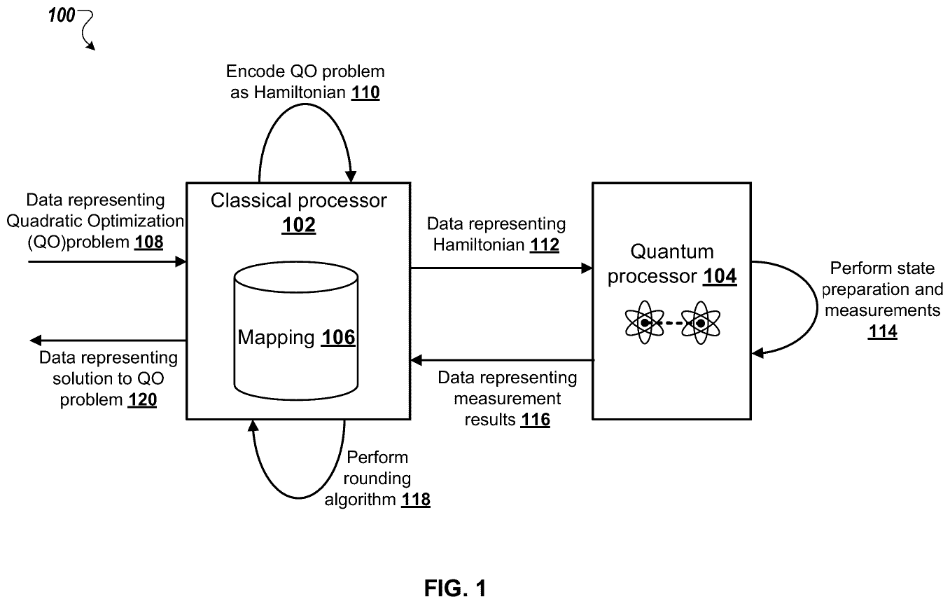

FIG. 1 shows a conceptual block diagram of an example system 100 solving a quadratic optimization problem over an orthogonal group using classical and quantum computation. The example system 100 includes a classical processor 102 and a quantum processor 104. The classical processor 102 and quantum processor 104 can electronic communications over one or more networks, or can exchange communications in another way, such as over one or more wired or wireless connections.

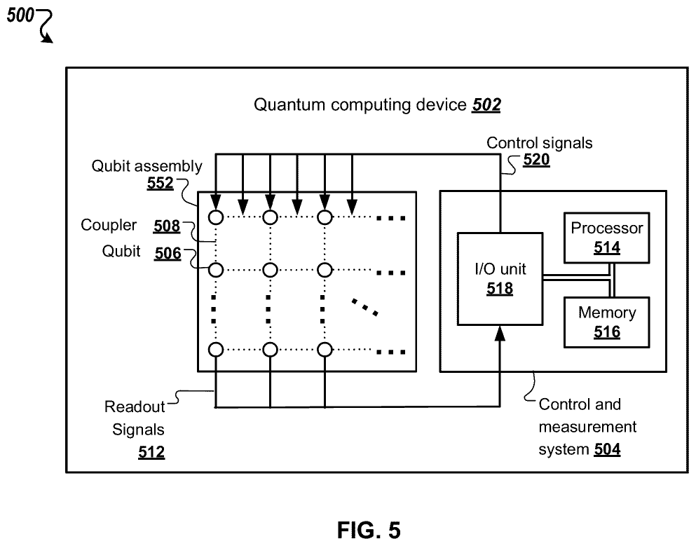

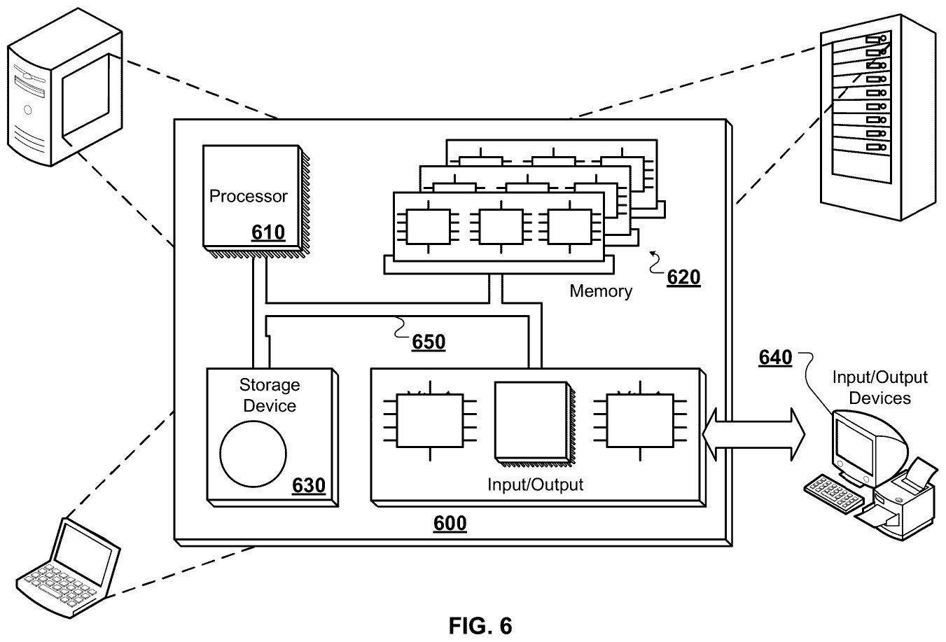

The classical processor 102 is configured to perform classical computations. The quantum processor 104 is configured to perform quantum computations. For convenience, the classical processor 102 and quantum processor 104 are illustrated as separate entities. For example, the quantum processor 104 can be a quantum processor that is operated by an external third party. However, in some implementations the classical processor 102 can be included in the quantum processor 104. That is, the quantum processor 104 can also include components for performing classical computing operations. Generally, the classical computing components of the classical processor can be implemented as one or more classical computers having physical hardware like that described with respect to FIG. 6 and the quantum computing components of the quantum processor 104 can be implemented as quantum computing devices having physical hardware like that described with respect to FIG. 5.

Example system 100 is configured to perform operations for solving quadratic optimization problems over an orthogonal group using classical and quantum computation. An orthogonal group in dimension n, denoted O(n), is a mathematical group of n×n orthogonal matrices, where an orthogonal matrix is a real matrix whose inverse equals its transpose. The orthogonal group has a group operation is given by matrix multiplication. An orthogonal group that contains the matrices with determinant 1 is a normal subgroup, called the special orthogonal group, and denoted SO(n). A quadratic optimization problem over an orthogonal group G=O(n) or G=SO(n) can be defined as follows: let (V, E) be a graph where each edge (u, v)∈E is associated with a matrix of real valued coefficients Cᵤᵥ∈ [symbol] ^{n×n} and the vertices are labelled by V=[m]. The goal of the quadratic optimization problem is to assign elements to the matrices Rᵥ∈O(n) for each v∈V such that the objective function

$$f ( {R}_{1} , … , {R}_{m} ) = {\sum }_{( u , v ) ∈ E} t r ( {C}_{u v}^{T} {R}_{u} {R}_{v}^{T} ) . \qquad ( 1 )$$

is maximized, where tr denotes the trace operation. The hardness of this problem is evident already when G=O(1)={±1}, which contains as a special case the NP-hard MAXCUT problem. For larger n, the above formulation can therefore be thought of as a generalization of MAXCUT to continuous, noncommutative variables.

The classical processor 102 is configured to receive input data specifying the quadratic optimization problem 108. For example, the classical processor 102 can receive data specifying the objective function given by Eq. 1 above, e.g., data specifying the size of the orthogonal group and the coefficients Cᵤᵥ∈ [symbol] ^{n×n}.

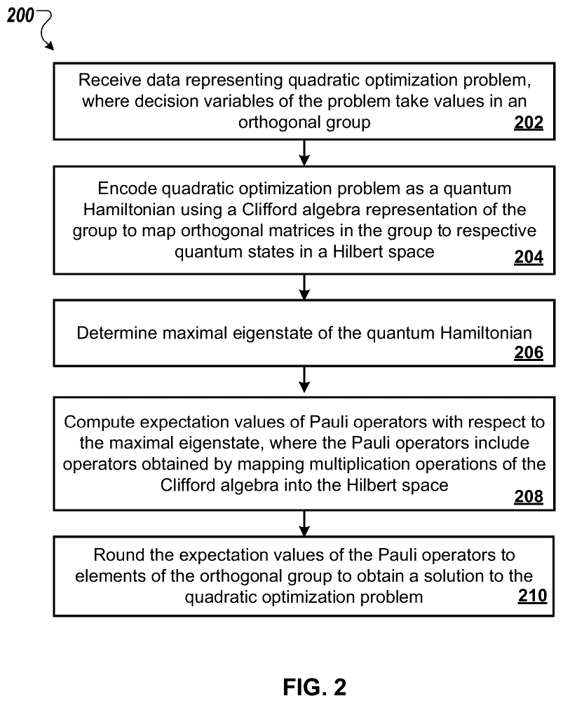

The classical processor 102 is configured to encode the quadratic optimization problem as a quantum Hamiltonian 110. In particular, the classical processor 102 is configured to apply a quadratic mapping 106 to the objective function defined by the input data 108. The quadratic mapping 106 maps orthogonal matrices in the orthogonal group to respective quantum states in a Hilbert space. The quadratic mapping 106 is based on a Clifford algebra representation of the orthogonal group and is described in more detail below with reference to FIG. 2. Under the quadratic mapping 106, the objective function is converted from a classical format, e.g., a format that is acceptable to a classical computing device, into a quantum format, e.g., a format that is acceptable to a quantum computing device. More specifically, the objective function is formulated as a qubit Hamiltonian. Values of the objective function for a given element of the orthogonal group Q(ϕ)∈G is therefore equivalent to an energy of the corresponding Hamiltonian with respect to the state |ϕ [symbol] ∈ [symbol] _{d}. The task of maximizing the objective function given by Eq. 1 is therefore mapped to the task of maximizing an energy of the corresponding Hamiltonian.

The classical processor 102 is configured to transmit data representing the quantum Hamiltonian to the quantum processor 104. The quantum processor 104 is configured to receive the data 112 and to determine an approximate eigenstate of the quantum Hamiltonian, e.g., a maximal eigenstate or an eigenstate that increases the energy over an initial state. For example, the quantum processor 104 can be configured to implement a phase estimation algorithm or train a variational quantum circuit to determine the eigenstate. The accuracy of the determined eigenstate depends on the techniques used to determine the eigenstate. The quantum processor 104 can then prepare the (approximate) eigenstate and measure the qubit operators Pᵢⱼ, Γᵢⱼ defined below with reference to FIG. 2 with respect to the (approximate) eigenstate 114. For example, the quantum processor 104 can be configured to repeatedly: prepare the (approximate) eigenstate of the Hamiltonian using ground state preparation or approximate group state preparation techniques (e.g., prepare a plurality of physical qubits in an (approximate) eigenstate of the Hamiltonian), apply a quantum circuit that evolves the (approximate) eigenstate according to the qubit operators (e.g., applies a quantum circuit to the plurality of physical qubits using a control system), and measure the evolved quantum state (e.g., measures the plurality of physical qubits using a measurement system).

The quantum processor 104 is configured to transmit data representing results of the measurement operations 116 to the classical processor 102. The classical processor 102 is configured to receive the transmitted data 116 and compute expectation values of the qubit operators with respect to the (approximate) eigenstate, e.g., by averaging over the measurement results 116 received from the quantum processor 104. The computed expectation values define an initial solution to the quadratic optimization problem.

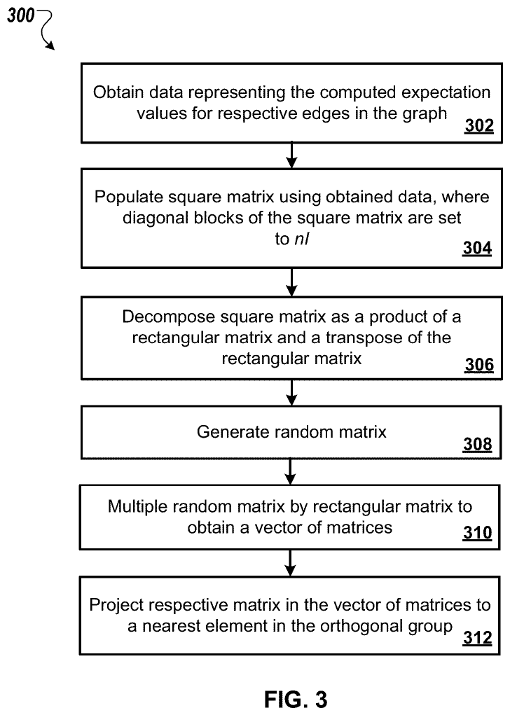

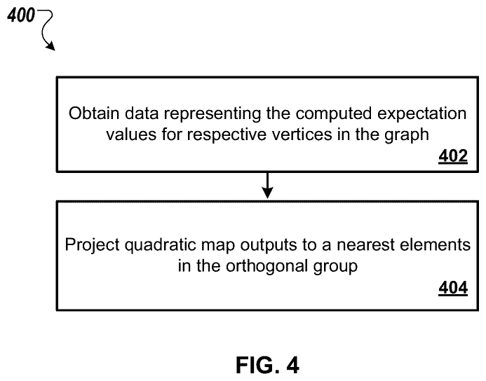

The Hamiltonian obtained through application of the quadratic mapping 106 is equivalent to a fermionic Hamiltonian with two-body interactions. Therefore, the space of quantum states is larger than the orthogonal group, so not every quantum state maps onto an orthogonal matrix via the quadratic mapping 106. The Hamiltonian obtained through application of the quadratic mapping 106 therefore corresponds to a relaxation of the original problem, e.g., its maximal eigenvalue is generically larger than the value of the objective function given by Eq. 1. Therefore, the classical processor 102 is configured to apply rounding algorithms 118 to the expectation values to project the initial solution back into the feasible solution space, e.g., recover orthogonal matrices from the relaxed initial solutions. For example, the classical processor 102 can be configured to perform one or both of the rounding algorithms described below with reference to FIGS. 3 and 4. The rounded expectation values are matrices Rᵥ∈O(n) or SO(n) that maximize the objective function given by Eq. 1 above.

The classical processor 102 is configured to output data representing a solution to the quadratic optimization problem 120, e.g., data specifying the rounded expectation values.

FIG. 2 is a flow diagram of an example process 200 for solving a quadratic optimization problem over an orthogonal group using classical and quantum computation. For convenience, the process 200 will be described as being performed by a system of one or more classical and quantum computing devices located in one or more locations. For example, the system 100 shown in FIG. 1, appropriately programmed, can perform example process 200.

The system receives data representing the quadratic optimization problem (step 202). As described above with reference to Eq. 1, the decision variables of the quadratic optimization problem take values in an orthogonal group, e.g., an orthogonal group in dimension n≥1 or a special orthogonal group in dimension n≥1. The group operation is matrix multiplication, which provides the quadratic form of the optimization problem. The received data can include data in the form of matrices, e.g., a collection of matrices Cᵤᵥ∈ [symbol] ^{n×n} that form a (u, v)th n×n block of a positive semidefinite matrix C∈ [symbol] ^{nm×nm}, as described above with reference to Eq. 1. In some implementations the matrices Cᵤᵥ can represent images or measurements, e.g., of 2D electron micrograph projections.

In some implementations the quadratic optimization problem is a little noncommutative Grothendieck problem, as described above.

The system encodes the quadratic optimization problem as a quantum Hamiltonian (step 204). The quantum Hamiltonian includes two-body fermionic interactions. To encode the quadratic optimization problem as a quantum Hamiltonian the system uses a Clifford algebra representation of the group to map orthogonal matrices in the group to respective quantum states in a Hilbert space.

The Clifford algebra Cl(n) is a 2ⁿ-dimensional vector space and can be identified with a Hilbert space of n qubits. To encode the quadratic optimization problem as a quantum Hamiltonian the system maps basis elements e_{I} of the Clifford algebra to respective computational basis states |e_{I} [symbol] ≡⊗_{i∈[n]}|bᵢ [symbol] in the Hilbert space, where bᵢ=1 if i∈I and bᵢ=0 otherwise. The inner products on both spaces coincide since this associates one orthonormal basis to another. This correspondence also naturally equates the grade (number of products of generators) of the Clifford algebra with the Hamming weight of the qubit states, in their respective standard bases. The notion of parity is then also preserved between this isomorphism, as parity is simply the grade/Hamming weight modulo 2.

To represent the multiplication operation of the algebra in this Hilbert space, the system maps a left multiplication operation of the Clifford algebra and a right multiplication operation of the Clifford algebra to respective n-qubit operators on the Hilbert space. Left- and right-multiplication are linear automorphisms, which are denoted by λₓ, ρₓ:Cl(n)→Cl(n) for elements x, y:

$$\begin{matrix}{λ}_{x} ( y ) = xy , & {ρ}_{x} ( y ) = yx .\end{matrix} \qquad ( 2 )$$

Therefore, the action of the algebra can be represented on [symbol] ₂_{ⁿ} as linear operators. Because of linearity, it suffices to specify left- and right-multiplication by the generators eᵢ. The left multiplication operation of the Clifford algebra for an i-th basis element is mapped to an n-qubit operator given by λᵢ below and the right multiplication operation of the Clifford algebra for an i-th basis element is mapped to an n-qubit operator given by ρᵢ below

$$\begin{matrix}{λ}_{i} ≡ {Z}^{⊗ ( i - 1 )} ⊗ ( - iY ) ⊗ {I}_{2}^{⊗ ( n - i )} \\ {ρ}_{i} ≡ {I}_{2}^{⊗ ( i - 1 )} ⊗ ( - iY ) ⊗ {Z}^{⊗ ( n - i )}\end{matrix} \qquad ( 3 )$$

where Z represents the Pauli Z operator, Y represent the Pauli Y operator, I represents the identity operator, and ⊗ represents the tensor product operator.

The parity of the Clifford algebra is translated to the parity of the qubit computational basis, so that the parity auto morphism a is equivalent to the n-qubit parity operator,

$$α ≡ {Z}^{⊗ n} \qquad ( 4 )$$

where Z represents the Pauli Z operator.

The double cover of the group SO(n) can be obtained from the even-parity sub algebra Cl⁰(n). This subspace has only half the dimension of Cl(n), since only half of the basis vectors e_{I} feature |I| mod 2=0. It is therefore useful to specify a projection operator from Cl(n) to Cl⁰(n), or equivalently from [symbol] ₂_{ⁿ} to [symbol] ₂_{ⁿ⁻¹}. This mapping can be given by the 2ⁿ⁻¹×2ⁿ matrix

$${\prod }_{0} = \frac{1}{√ 2} ( 〈 + \vert ⊗ {I}_{2}^{⊗ ( n - 1 )} + 〈 - \vert ⊗ {Z}^{⊗ ( n - 1 )} ) . \qquad ( 5 )$$

where [symbol] +| represents a plus state and [symbol] −| represents a minus state.

The above described mappings connect objects in the Clifford algebra to objects in Hilbert space, e.g., quantum states and qubit operators. These quantities can be further linked to physical quantum systems and measurements by defining a quadratic mapping that can be applied to elements of the Clifford algebra. The quadratic mapping maps inputs in a vector space with dimension 2ⁿ (e.g., elements from the Clifford algebra) to respective outputs in a vector space with dimension n×n (e.g., elements in the Hilbert space), where matrix elements of each output include expectation values of combinations of the n-qubit operators described above with reference to Eq. 3.

In the standard basis of [symbol] ⁿ, the linear map Q(x): [symbol] ⁿ→ [symbol] ⁿ has the matrix elements

$${[ Q ( x ) ]}_{i j} = 〈 {e}_{i} , Q ( x ) ( {e}_{j} ) 〉 = 〈 {e}_{i} , α ( x ) {e}_{j} x 〉 . \qquad ( 6 )$$

where the notation [symbol] A, B [symbol] =tr(A^{T}B) denotes the Frobenius inner product on matrices.

Using the linear maps λᵢ, ρⱼ of left- and right-multiplication by eᵢ, eⱼ as described above with reference to Eq. 3, as well as the conjugation identity [symbol] x, yz̅ [symbol] = [symbol] xz, y [symbol] , these matrix elements of Q (x) can be rearranged as

$${[ Q ( x ) ]}_{i j} = 〈 {e}_{i} , α ( x ) {e}_{j} x 〉 = 〈 {e}_{i} x , α ( x ) {e}_{j} 〉 = 〈 {λ}_{i} ( x ) , {ρ}_{j} ( α ( x ) ) 〉 = 〈 x , {λ}_{i}^{†} ( {ρ}_{j} ( α ( x ) ) ) 〉 . \qquad ( 7 )$$

This expression can be transferred to the quantum representation developed above. First, the n-qubit Pauli operators

$${P}_{ij} := {λ}_{i}^{†} {ρ}_{j} α = \{ \begin{matrix}- {I}_{2}^{⊗ ( i - 1 )} ⊗ X ⊗ {Z}^{⊗ ( j - i - 1 )} ⊗ X ⊗ {I}_{2}^{⊗ ( n - j )} & i < j \\ {I}_{2}^{⊗ ( i - 1 )} ⊗ Z ⊗ {I}_{2}^{⊗ ( n - i )} & i = j \\ - {I}_{2}^{⊗ ( j - 1 )} ⊗ Y ⊗ {Z}^{⊗ ( i - j - 1 )} ⊗ Y ⊗ {I}_{2}^{⊗ ( n - i )} & i > j\end{matrix} , \qquad ( 8 )$$

are defined, where i,j represent Clifford algebra basis indices, X represents the Pauli X operator, Z represents the Pauli Z operator, Y represent the Pauli Y operator, I represents the identity operator, and the explicit expressions follow from Eqs. 4 and 5. It then follows that

$${[ Q ( x ) ]}_{i j} = 〈 x \vert {P}_{i j} \vert x 〉 , \qquad ( 9 )$$

where |x [symbol] ∈ [symbol] ₂_{ⁿ} is the quantum state identified with x∈Cl(n). Hence, the matrix elements of an output of the mapping Q(x)∈ [symbol] ^{n×n} can be obtained by computing expectation values of a collection of n² Pauli observables. Furthermore, this matrix Q(x) is orthogonal if and only if x∈Pin(n), and lies in SO(n) if and only if x∈Spin(n). In general, these double covers are only a subset of the unit sphere in [symbol] _{d}, so not all quantum states mapped by Q yield orthogonal matrices.

Eq. 8 corresponds to optimization over the orthogonal group. The (n−1)-qubit operator for optimization over the special orthogonal group is defined as \tilde{P}ᵢⱼ=Π₀PᵢⱼΠ₀^{T} where

$${\prod }_{0} = \frac{1}{√ 2} ( 〈 + \vert ⊗ {I}_{2}^{⊗ ( n - 1 )} + 〈 - \vert ⊗ {Z}^{⊗ ( n - 1 )} ) ,$$

i, j represent Clifford algebra basis indices, Z represents the Pauli Z operator, and [symbol] +|, [symbol] −| represent a plus state and minus state, respectively.

The Clifford-algebraic formulation of the elements of the orthogonal group provides an encoding of the quadratic optimization problem into a quantum Hamiltonian. The objective function ƒ(R₁, . . . , Rₘ) (as defined in Eq. 1) can be expanded explicitly in terms of matrix elements:

$${\sum }_{( u , v ) ∈ E} 〈 {C}_{uv} , {R}_{u} {R}_{v}^{T} 〉 = {\sum }_{( u , v ) ∈ E} {\sum }_{i , j ∈ [ n ]} {[ {C}_{uv} ]}_{ij} {\sum }_{k ∈ [ n ]} {{[ {R}_{u} ]}_{ik} [ {R}_{v}^{T} ]}_{kj} . \qquad ( 10 )$$

From the quadratic mapping Q:Cl(n)→ [symbol] ^{n×n}, it is known that for each R∈G there exists some x∈ [symbol] such that Rᵢⱼ= [symbol] x|Pᵢⱼ|x [symbol] . Therefore, the matrix product can be expressed as

$${{[ {R}_{u} ]}_{i k} [ {R}_{v}^{T} ]}_{k j} = 〈 {x}_{u} \vert {P}_{i k} \vert {x}_{u} 〉 〈 {x}_{v} \vert {P}_{j k} \vert {x}_{v} 〉 = 〈 {x}_{u} ⊗ {x}_{v} \vert {P}_{i k} ⊗ {P}_{j k} \vert {x}_{u} ⊗ {x}_{v} 〉 , \qquad ( 11 )$$

which is now the expectation value of a 2n-qubit Pauli operator with respect to a product state (separable over two subsystems of n qubits each). To extend this over all m vertices, a Hilbert space of mn qubits is defined, which is naturally partitioned into m registers of n qubits. For each edge (u, v) the following Hamiltonian terms are introduced:

$${H}_{uv} = {\sum }_{i , j ∈ [ n ]} {[ {C}_{uv} ]}_{ij} {Γ}_{ij}^{( u , v )} \qquad ( 12 )$$

$$where$$

$${Γ}_{ij}^{( u , v )} = ( {\sum }_{k ∈ [ n ]} {P}_{i k}^{( u )} ⊗ {P}_{jk}^{( v )} ) {⊗}_{w ϵ V \backslash \{ u , v \}} {1}^{( w )} . \qquad ( 13 )$$

To simplify notation, the identity operators in the tensor product are suppressed when the context is clear.

The quadratic optimization problem is now reformulated as optimizing the mn-qubit Hamiltonian

$$H = {\sum }_{( u , v ) ∈ E} {H}_{uv} = {\sum }_{( u , v ) ∈ E} {\sum }_{i , j ∈ [ n ]} {[ {C}_{uv} ]}_{ij} {\sum }_{k ∈ [ n ]} {P}_{i k}^{( u )} ⊗ {P}_{jk}^{( v )} . \qquad ( 14 )$$

The quantum state which optimizes the classical objective function is a product state over the local qudits: |ψ [symbol] =⊗_{v∈V}|xᵥ), where furthermore each xᵥ∈ [symbol] , or equivalently each |xᵥ [symbol] is a Slater determinant of appropriate parity. Because such states constitute only a subset of all quantum states, it follows that the maximal eigenvalue of H provides an upper bound to the optimal desired objective value:

$${λ}_{max} ( H ) \geq {max}_{R ∈ {G}^{m}} f ( R ) . \qquad ( 15 )$$

In other words, the presently described quantum formulation produces an outer approximation to the original problem. The approximations can be rounded to recover a feasible quantum solution using classical post-processing, as described below with reference to FIGS. 3 and 4. (Note that in the physics literature the minimum value of a Hamiltonian's energy, called the ground-state energy, is of interest because of the physical relevance of ground states. On the other hand, the computer science convention typically phrases problems in terms of maximization. The computer science convention is adopted here. In this context both perspectives are equivalent.)

Returning to FIG. 2, the system uses a quantum computer to determine an (approximate) eigenstate of the quantum Hamiltonian (step 206). For example, the system can perform known techniques such as quantum phase estimation or a variational algorithm to determine an approximation of the quantum state |ψ [symbol] ∈H_{d}^{⊗m} that maximizes the energy [symbol] ψ|H|ψ [symbol] . The quantum state |ψ [symbol] can be a pure or mixed state.

The system uses the quantum computer to compute expectation values of Pauli operators with respect to the (approximate) maximal eigenstate, where the Pauli operators include the operators obtained by mapping the multiplication operations of the Clifford algebra into the Hilbert space as given by Eq. 8 above (step 208). For example, the system can prepare copies of the (approximate) maximal eigenstate of the quantum Hamiltonian, e.g., using ground state preparation or approximate ground state preparation techniques, and measure the operators Pᵢⱼ and Γᵢⱼ with respect to the copies of the (approximate) maximal eigenstate to compute the expectation values [symbol] ψ|Pᵢⱼ|ψ [symbol] and [symbol] ψ|Γᵢⱼ|ψ). For example, the system can measure fermionic one-particle reduced density matrices (1-RDMs) or two-particle reduced density matrices (2-RDMs).

The system uses the classical computer to round the expectation values of the Pauli operators to elements of the orthogonal group to obtain a solution to the quadratic optimization problem (step 210). For example, the system can perform one (or both) of the algorithms described below with reference to FIGS. 3 and 4. The first algorithm requires measuring the expectation values of the operators Γᵢⱼ^{(u,v)}=Σ_{k∈[n]}Pᵢⱼ^{(u)}⊗Pⱼₖ^{(v)} for each pair of vertices (u, v) in a graph formulation of the quadratic optimization problem. Because this information content involves the quantum marginals of |ψ [symbol] across edges, this procedure is referred to herein as edge-marginal rounding. The second algorithm rounds the expectation values of Pᵢⱼ^{(u)} of each vertex v in the graph directly. In this case only the information arising from the quantum marginals of individual vertices is required, so this approach is referred to herein as vertex-marginal rounding. In both algorithms, the relevant expectation values can be efficiently estimated using techniques such as partial state tomography. The rounding algorithms then operate as classical post-processing after obtaining the necessary matrix elements.

The system can provide data representing the rounded expectation values (which are the optimized decision variables, as described in more detail below with reference to FIGS. 3 and 4) and the coefficients Cᵤᵥ that form the positive semidefinite matrix as output.

FIG. 3 is a flow diagram of an example process 300 for edge-marginal rounding of a quantum state. For convenience, the process 300 will be described as being performed by a system of one or more classical and quantum computing devices located in one or more locations. For example, the system 100 of FIG. 1, appropriately programmed, can perform example process 300.

The quadratic optimization problem described above with reference to step 202 of example process 200 defines a graph of vertices and edges (V, E), where each edge (u, v)∈E a matrix Cᵤᵥ∈ [symbol] ^{n×n} and vertices are labelled by V=[m]. The task of solving the quadratic optimization problem is then the task of assigning Rᵥ∈G for each v∈V such that the objective function ƒ(R₁, . . . , Rₘ)=Σ_{(u,v)∈E}tr(Cᵤᵥ^{T}RᵤRᵥ^{T}) is maximized.

The system obtains data representing expectation values [symbol] ψ|Γᵢⱼ^{(u,v)}|ψ [symbol] for respective edges (u, v) in the graph (step 302). For each pair of vertices u, v∈V, u≠v, the operators Γᵢⱼ(u,v) are given by

$${Γ}_{ij}^{( u , v )} = {\sum }_{k ∈ [ n ]} {P}_{i k}^{( u )} ⊗ {P}_{j k}^{( v )} \qquad ( 16 )$$

for all i,j∈[n]. The system can receive this data from the quantum computer or classical computer after step 208 of example process 200 is performed. The operator Γᵢⱼ^{(u,v)} is constructed such that, if the state is a tensor product of [symbol] elements, then its expectation value returns the matrix element of the product of two orthogonal matrices:

$$〈 {x}_{u} ⊗ {x}_{v} \vert {Γ}_{ij}^{( u , v )} \vert {x}_{u} ⊗ {x}_{v} 〉 = {\sum }_{k ∈ [ n ]} 〈 {x}_{u} \vert {P}_{i k}^{( u )} \vert {x}_{u} 〉 〈 {x}_{v} \vert {P}_{j k}^{( v )} \vert {x}_{v} 〉 = {\sum }_{k ∈ [ n ]} {{[ {R}_{u} ]}_{i k} [ {R}_{v} ]}_{j k} = {[ {R}_{u} {R}_{v}^{T} ]}_{i j} \qquad ( 17 )$$

For general states, however, these expectation values will not form an orthogonal matrix.

Therefore, the system uses the data obtained at step 302 to populate a square matrix M (step 304). The system collects the data into a large nm×nm block matrix

$$M = [ \begin{matrix}nI & {X}_{12} & … \\ {X}_{21} & nI & … \\ ⋮ & ⋮ & ⋱\end{matrix} ] \qquad ( 18 )$$

where Xᵤᵥ∈ [symbol] ^{n×n} is defined, for u<v, as

$${[ {X}_{u v} ]}_{i j} = 〈 ψ \vert {Γ}_{i j}^{( u , v )} \vert ψ 〉 \qquad ( 19 )$$

To ensure that M is positive semidefinite, the object Xᵥᵤ is defined as Xᵥᵤ=[Xᵤᵥ]^{T} and the diagonal blocks are set to nI, since M=nI+X≥0.

The system decomposes the square matrix as a product of i) a rectangular matrix and ii) a transpose of the rectangular matrix (step 306). Because the square matrix M≥0, it decomposes into the form M=LL^{T} for some L∈ [symbol] ^{nm×nm} for example via the Cholesky decomposition. This provides a form for the square matrix M as a Gram matrix, where each n×n block of M, Mᵤᵥ=LᵤLᵥ^{T}, is the product of rectangular matrices Lᵥ∈ [symbol] ^{n×nm} such that

$$L = [ \begin{matrix}{L}_{1} \\ ⋮ \\ {L}_{m}\end{matrix} ] .$$

The system generates a random matrix (step 308). For example, the system can sample values from a normal distribution [symbol] (0, 1/n) and generate a random matrix Z∈ [symbol] ^{nm×n} using the sampled values.

The system multiplies the random matrix Z by the rectangular matrix L to obtain a vector of matrices L Z (step 310).

For each vertex in the graph, the system projects a respective matrix in the vector of matrices to a nearest element in the orthogonal group (step 312). That is, the system identifies the nearest (special) orthogonal matrix as

$${R}_{v} = arg {min}_{Y ∈ G} {‖ Y - {L}_{v} Z ‖}_{F} \qquad ( 20 )$$

for each v∈V. In some implementations the system can compute Rᵥ by computing a singular value decomposition of the vector of matrices LᵥZ. The collection of Rᵥ for each v∈V are then provided as a solution to the quadratic optimization problem.

Example process 300 can be expressed in pseudocode as:

Data: |ψ [symbol] ϵ [symbol] _{d}^{⊗m}
Result: R₁, . . . , Rₘ ϵ G
M ← 0 ϵ [symbol] ^{nm×nm} ;
for u, v ϵ [m] do

| \| | if u = v then | | |
|---|---|---|---|
| \| | \| | Mᵤᵥ ← nI ; | |
| \| | else | | |
| \| | \| | for (i, j) ϵ [n]² do | |
| \| | \| | \| | [Mᵤᵥ]ᵢⱼ ← [symbol] φ\|Γᵢⱼ^{(u,v)}\|ψ [symbol] ; |

| | | |
|---|---|---|
| \| | \| | end |

| | |
|---|---|
| \| | end |

end
Cholesky decompose M = LL^{T} ;
Generate random S ϵ [symbol] ^{nm×n} with orthonormal columns ;
[\hat{Q}₁ . . . \hat{Q}ₘ]^{T} ← LS ;
for v ϵ [m] do

| | |
|---|---|
| \| | Rᵥ ← arg min_{XϵG} ∥X − \hat{Q}ᵥ∥_{F}² ; |

end

where the input data is a quantum state |ψ [symbol] over a graph of m vertices, each with a local Hilbert space of dimension d=2ⁿ if G=O(n) or d=2ⁿ⁻¹ if G=SO(n), and the output data is orthogonal matrices on each vertex R₁, . . . , Rₘ∈G.

FIG. 4 is a flow diagram of an example process 400 for vertex-marginal rounding of a quantum state. For convenience, the process 400 will be described as being performed by a system of one or more classical and quantum computing devices located in one or more locations. For example, the system 100 of FIG. 1, appropriately programmed, can perform example process 400.

The quadratic optimization problem described above with reference to step 202 of example process 200 defines a graph of vertices and edges (V, E), where each edge (u, v)∈E a matrix Cᵤᵥ∈ [symbol] ^{n×n}, and vertices are labelled by V=[m]. The task of solving the quadratic optimization problem is then the task of assigning Rᵥ∈G for each v∈V such that the objective function ƒ(R₁, . . . , Rₘ)=Σ_{(u,v)∈E}tr(Cᵤᵥ^{T}RᵤRᵥ^{T}) is maximized.

The system obtains data representing expectation values [symbol] ψ|Pᵢⱼ^{(v)}|ψ [symbol] for respective vertices v in the graph (step 402). The operator Pᵢⱼ for a vertex v is defined above with reference to Eq. 8. The system can receive this data from the quantum computer or classical computer after step 208 of example process 200 is performed.

Single-vertex marginals are defined by tracing out the qudits associated to all but one vertex,

$${σ}_{v} = t {r}_{{¬}_{v}} ( \vert ψ 〉 〈 ψ \vert ) . \qquad ( 21 )$$

The matrix Rᵥ is then the image of σᵥ under (the convex extension of) the quadratic map Q. To see this, consider the spectral decomposition σᵥ=Σ_{α}p_{α}|ϕ_{α} [symbol] ϕ_{α}|. The corresponding convex combination of Q(ϕ_{α}) is defined as

$$\begin{matrix}{\sum }_{α} {p}_{α} Q ( {ϕ}_{α} ) = {\sum }_{α} {p}_{α} {\sum }_{i , j ∈ [ n ]} tr ( {P}_{ij} \vert {ϕ}_{α} 〉 〈 {ϕ}_{α} \vert ) {e}_{i} {e}_{j}^{T} \\ = {\sum }_{i , j ∈ [ n ]} tr ( {P}_{ij} {σ}_{v} ) {e}_{i} {e}_{j}^{T} \\ = Q ( {σ}_{v} ) .\end{matrix} \qquad ( 22 )$$

This matrix does not necessarily lie in G, but rather its convex hull conv(G).

Therefore, for each vertex in the graph, the system projects Q(σᵥ) to a nearest element in the orthogonal group (step 404). That is, the system identifies the nearest (special) orthogonal matrix as

$${R}_{v} = arg {min}_{X ∈ G} {‖ X - Q ( {σ}_{v} ) ‖}_{F}^{2} \qquad ( 23 )$$

for each v∈V, where Q(σᵥ) is defined in Eq. 9. In some implementations the system can compute Rᵥ by computing a singular value decomposition of Q(σᵥ), e.g., writing the special singular decomposition of Q(σᵥ)=Uᵥ\tilde{Σ}ᵥVᵥ^{T} gives Rᵥ=UᵥVᵥ^{T}.

Performing this rounding procedure on each vertex returns a feasible solution. The collection of Rᵥ for each v∈V are then provided as a solution to the quadratic optimization problem. It is noted that in principle this corresponds to rounding |ψ [symbol] to a product state ⊗_{v∈V}|xᵥ [symbol] where each xᵥ∈ [symbol] . Because each |xᵥ [symbol] is equivalent to a Slater determinant, its fermionic one-body reduced density matrix fully specifies it, hence the n² expectation values of fermionic one-body observables Pᵢⱼ=i\tilde{γ}ᵢγⱼ suffice to completely represent it.

Example process 400 can be expressed in pseudocode as:

| Data: \|ψ [symbol] ϵ [symbol] _{d}^{⊗m} | | |
|---|---|---|
| Result: R₁, . . . , Rₘ ϵ G | | |
| for v ϵ [m] do | | |
| \| | \hat{Q}ᵥ ← 0 ϵ [symbol] ^{n×n} ; | |
| \| | for (i, j) ϵ [n]² do | |
| \| | \|\| | \|\hat{Q}ᵥ]ᵢⱼ ← [symbol] ψ\|Pᵢⱼ^{(v)}\|ψ [symbol] ; |

| \| | end |
|---|---|
| end | |
| for v ϵ [m] do | |
| \|\| | Rᵥ ← arg min_{XϵG} ∥X − \hat{Q}ᵥ∥_{F}² ; |

end

where the input data is a quantum state |ψ [symbol] over a graph of m vertices, each with a local Hilbert space of dimension d=2ⁿ if G=O(n) or d=2ⁿ⁻¹ if G=SO(n), and the output data is orthogonal matrices on each vertex R₁, . . . , Rₘ∈G.

FIG. 5 depicts an example quantum computer 500 for performing the quantum operations described in this specification. The example quantum computer 500 includes an example quantum computing device 502. The quantum computing device 502 is intended to represent various forms of quantum computing devices. The components shown here, their connections and relationships, and their functions, are exemplary only, and do not limit implementations of the inventions described and/or claimed in this document.

The example quantum computing device 502 includes a qubit assembly 552 and a control and measurement system 504. The qubit assembly includes multiple qubits, e.g., qubit 506, that are used to perform algorithmic operations or quantum computations. While the qubits shown in FIG. 5 are arranged in a rectangular array, this is a schematic depiction and is not intended to be limiting. The qubit assembly 552 also includes adjustable coupling elements, e.g., coupler 508, that allow for interactions between coupled qubits. In the schematic depiction of FIG. 5, each qubit is adjustably coupled to each of its four adjacent qubits by means of respective coupling elements. However, this is an example arrangement of qubits and couplers and other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 502 included in the example computer 500 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits may be realized via superconducting qubits or semi-conducting qubits, e.g., superconducting transmon states. As another example, in a NMR quantum computer the qubits may be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits, e.g., to implement the qubit operators described in this specification. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), iSWAP gates, and gates involving three or more qubits, e.g., Toffoli gates. The quantum logic gates can be implemented by applying control signals 510 generated by the control and measurement system 504 to the qubits and to the couplers.

For example, in some implementations the qubits in the qubit assembly 552 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 510 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 510. The measurements cause readout signals 512 representing measurement results to be communicated back to the measurement and control system 504. The readout signals 512 may include RF, microwave, or optical signals depending on the physical scheme for the quantum computing device and/or the qubits. For convenience, the control signals 510 and readout signals 512 shown in FIG. 5 are depicted as addressing only selected elements of the qubit assembly (i.e. the top and bottom rows), but during operation the control signals 510 and readout signals 512 can address each element in the qubit assembly 552.

The control and measurement system 504 is an example of a classical computer system that can be used to perform various operations on the qubit assembly 552, as described above, as well as other classical subroutines or computations. The control and measurement system 504 includes one or more classical processors, e.g., classical processor 514, one or more memories, e.g., memory 516, and one or more I/O units, e.g., I/O unit 518, connected by one or more data buses. The control and measurement system 504 can be programmed to send sequences of control signals 510 to the qubit assembly, e.g. to carry out a selected series of quantum gate operations, and to receive sequences of readout signals 512 from the qubit assembly, e.g. as part of performing measurement operations.

The processor 514 is configured to process instructions for execution within the control and measurement system 504. In some implementations, the processor 514 is a single-threaded processor. In other implementations, the processor 514 is a multi-threaded processor. The processor 514 is capable of processing instructions stored in the memory 516.

The memory 516 stores information within the control and measurement system 504. In some implementations, the memory 516 includes a computer-readable medium, a volatile memory unit, and/or a non-volatile memory unit. In some cases, the memory 516 can include storage devices capable of providing mass storage for the system 504, e.g. a hard disk device, an optical disk device, a storage device that is shared over a network by multiple computing devices (e.g., a cloud storage device), and/or some other large capacity storage device.

The input/output device 518 provides input/output operations for the control and measurement system 504. The input/output device 518 can include D/A converters, A/D converters, and RF/microwave/optical signal generators, transmitters, and receivers, whereby to send control signals 510 to and receive readout signals 512 from the qubit assembly, as appropriate for the physical scheme for the quantum computer. In some implementations, the input/output device 518 can also include one or more network interface devices, e.g., an Ethernet card, a serial communication device, e.g., an RS-232 port, and/or a wireless interface device, e.g., an 802.11 card. In some implementations, the input/output device 518 can include driver devices configured to receive input data and send output data to other external devices, e.g., keyboard, printer and display devices.

Although an example control and measurement system 504 has been depicted in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

FIG. 6 illustrates a schematic diagram of an exemplary classical processor system 600. The system 600 can be used for the classical operations described in this specification according to some implementations. The system 600 is intended to represent various forms of digital computers, such as laptops, desktops, workstations, personal digital assistants, servers, blade servers, mainframes, mobile devices and other appropriate computers. The components shown here, their connections and relationships, and their functions, are exemplary only, and do not limit implementations of the inventions described and/or claimed in this document.

The system 600 includes a processor 610, a memory 620, a storage device 630, and an input/output device 640. Each of the components 610, 620, 630, and 620 are interconnected using a system bus 650. The processor 610 may be enabled for processing instructions for execution within the system 600. In one implementation, the processor 610 is a single-threaded processor. In another implementation, the processor 610 is a multi-threaded processor. The processor 610 may be enabled for processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 may be enabled for providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g. photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer implemented method comprising:
receiving, by a classical computer, data representing a quadratic optimization problem, wherein decision variables of the quadratic optimization problem take values in an orthogonal group or a special orthogonal group;
encoding, by a classical computer, the quadratic optimization problem as a quantum Hamiltonian, the encoding comprising using a Clifford algebra representation of the group to map orthogonal matrices or special orthogonal matrices in the group to respective quantum states in a Hilbert space;
determining, by a quantum computer, an approximate eigenstate of the quantum Hamiltonian;
computing, by the quantum computer, expectation values of Pauli operators with respect to the approximate eigenstate, wherein the Pauli operators comprise operators obtained by mapping multiplication operations of the Clifford algebra into the Hilbert space; and
rounding, by the classical computer, the expectation values of the Pauli operators to elements of the orthogonal group to obtain a solution to the quadratic optimization problem.

2. The method of claim 1, wherein the orthogonal group comprises an orthogonal group in dimension n≥1 or a special orthogonal group in dimension n≥1, wherein a group operation is given by matrix multiplication.

3. The method of claim 1, wherein using the Clifford algebra representation of the group to map orthogonal matrices in the group to respective quantum states in the Hilbert space comprises:
mapping basis elements of the Clifford algebra in a 2ⁿ-dimensional vector space to respective computational basis states in a Hilbert space of dimension 2ⁿ, wherein n represents the dimension of the group; and
mapping a left multiplication operation of the Clifford algebra and a right multiplication operation of the Clifford algebra to respective n-qubit operators on the Hilbert space.

4. The method of claim 3, wherein the left multiplication operation of the Clifford algebra for an i-th basis element is mapped to an n-qubit operator given by Z^{⊗(i-1)}⊗(−iY)⊗I₁^{⊗(n-i)} and the right multiplication operation of the Clifford algebra for an i-th basis element is mapped to an n-qubit operator given by I₂^{⊗(i-1)}⊗(−iY)⊗Z^{⊗(n-i)}, where Z represents the Pauli Z operator and Y represent the Pauli Y operator.

5. The method of claim 3, wherein using the Clifford algebra representation of the group to map orthogonal matrices in the group to respective quantum states in the Hilbert space comprises applying a quadratic mapping to elements of the Clifford algebra, wherein the quadratic mapping maps inputs in a vector space with dimension 2ⁿ to respective outputs in a vector space with dimension n×n, wherein matrix elements of each output comprise expectation values of the n-qubit operators on the Hilbert space.

6. The method of claim 5, wherein the matrix elements of an output of the quadratic mapping comprise expectation values of the n-qubit operators given by
$${P}_{ij} := {λ}_{i}^{†} {ρ}_{j} α = \{ \begin{matrix}- {I}_{2}^{⊗ ( i - 1 )} ⊗ X ⊗ {Z}^{⊗ ( j - i - 1 )} ⊗ X ⊗ {I}_{2}^{⊗ ( n - j )} & i < j \\ {I}_{2}^{⊗ ( i - 1 )} ⊗ Z ⊗ {I}_{2}^{⊗ ( n - i )} & i = j \\ - {I}_{2}^{⊗ ( j - 1 )} ⊗ Y ⊗ {Z}^{⊗ ( i - j - 1 )} ⊗ Y ⊗ {I}_{2}^{⊗ ( n - i )} & i > j\end{matrix} ,$$
where i,j represent Clifford algebra basis indices, X represents the Pauli X operator, Z represents the Pauli Z operator, and Y represent the Pauli Y operator.

7. The method of claim 5, wherein the matrix elements of an output of the quadratic mapping comprise expectation values of the n-qubit operators given by \tilde{P}ᵢⱼ=Π₀PᵢⱼΠ₀^{T} where
$${\prod }_{0} = \frac{1}{√ 2} ( 〈 + \vert ⊗ {I}_{2}^{⊗ ( n - 1 )} + 〈 - \vert ⊗ {Z}^{⊗ ( n - 1 )} ) ,$$
i, j represent Clifford algebra basis indices, Z represents the Pauli Z operator, and [symbol] +|, [symbol] −| represent a plus state and minus state, respectively.

8. The method of claim 1, wherein the quadratic optimization problem defines a graph of vertices and edges, and wherein rounding the computed expectation values to elements of the orthogonal group comprises implementing an edge-marginal rounding algorithm.

9. The method of claim 8, wherein implementing the edge-marginal rounding algorithm comprises:
decomposing a square matrix comprising expectation values for the edges in the graph as a product of a rectangular matrix and a transpose of the rectangular matrix;
generating a random normally distributed matrix;
multiplying the random matrix by the rectangular matrix to obtain a vector of matrices; and
for each vertex in the graph, projecting a respective matrix in the vector of matrices to a nearest element in the orthogonal group.

10. The method of claim 9, wherein projecting a respective matrix in the vector of matrices to a nearest element in the orthogonal group comprises computing a singular value decomposition of the vector of matrices.

11. The method of claim 1, wherein the quadratic optimization problem defines a graph of vertices and edges, and wherein rounding the computed expectation values to elements of the orthogonal group comprises implementing a vertex-marginal rounding algorithm.

12. The method of claim 11, wherein implementing the vertex-marginal rounding algorithm comprises, for each vertex in the graph, projecting a matrix comprising expectation values for the vertex to a nearest element in the orthogonal group.

13. The method of claim 12, wherein projecting a matrix comprising expectation values for the vertex to a nearest element in the orthogonal group comprises computing a singular value decomposition of the matrix comprising expectation values for the vertex.

14. The method of claim 1, wherein computing expectation values of Pauli operators with respect to the approximate eigenstate comprises:
preparing, by the quantum computer, copies of the approximate eigenstate using ground state preparation or approximate ground state preparation techniques; and
measuring, by the quantum computer, the copies of the approximate eigenstate, comprising measuring matrix elements of a 1-RDM or 2-RDM.

15. The method of claim 1, wherein determining the approximate eigenstate of the quantum Hamiltonian comprises performing quantum phase estimation or a variational algorithm, wherein the accuracy of the approximate eigenstate is dependent on the accuracy of the quantum phase estimation computation or variational algorithm.

16. The method of claim 1, wherein the received data comprises values of elements of a positive semidefinite matrix, and wherein the solution of the quadratic optimization problem comprises the rounded expectation values and the values of the elements of the positive semidefinite matrix.

17. The method of claim 1, wherein the quantum Hamiltonian comprises two-body fermionic interactions.

18. The method of claim 1, wherein the quadratic optimization problem comprises a little noncommutative Grothendieck problem over the orthogonal group or special orthogonal group.

19. The method of claim 1, wherein the eigenstate of the quantum Hamiltonian comprises a maximal eigenstate or an eigenstate that maximizes energy with respect to an initial state.

20. An apparatus comprising:
one or more classical processors; and
one or more quantum computing devices in data communication with the one or more classical processors;
wherein the apparatus is configured to perform operations comprising:
receiving, by a classical computer, data representing a quadratic optimization problem, wherein decision variables of the quadratic optimization problem take values in an orthogonal group or a special orthogonal group;
encoding, by a classical computer, the quadratic optimization problem as a quantum Hamiltonian, the encoding comprising using a Clifford algebra representation of the group to map orthogonal matrices or special orthogonal matrices in the group to respective quantum states in a Hilbert space;
determining, by a quantum computer, an approximate eigenstate of the quantum Hamiltonian;
computing, by the quantum computer, expectation values of Pauli operators with respect to the approximate eigenstate, wherein the Pauli operators comprise operators obtained by mapping multiplication operations of the Clifford algebra into the Hilbert space; and
rounding, by the classical computer, the expectation values of the Pauli operators to elements of the orthogonal group to obtain a solution to the quadratic optimization problem.
